(19) United States
(12) Patent Application Publication
(10) Pub. No.: US 2011/0134278 A1
(43) Pub. Date: Jun. 9, 2011

(54) IMAGE/AUDIO DATA SENSING MODULE AND IMAGE/AUDIO DATA SENSING METHOD

(76) Inventors: Chi-Tung Chang, Taipei (TW); Wen-Chao Tseng, Taipei (TW); I-Chieh Lin, Taipei (TW)

(21) Appl. No.: 12/719,861

(22) Filed: Mar. 9, 2010

(30) Foreign Application Priority Data
Dec. 4, 2009 (TW) 098141505

(51) Int. Cl. H04N 5/76

(52) U.S. Cl. 348/231.4; 348/E05.031

(57) ABSTRACT

An image/audio data sensing module incorporated in a case of an electronic apparatus. The image/audio data sensing module comprises: at least one image sensor, for sensing an image datum; a plurality of audio sensors, for sensing at least one audio datum; a processor, for processing the image datum and the audio datum according to a control instruction set to generate a processed image data stream and at least one processed audio data stream, and combining the processed image data stream and the processed audio data stream to generate an output data stream following a transceiver interface standard; a transceiver interface, for receiving the control instruction set and transmitting the output data stream via a multiplexing process; and a circuit board, wherein the image sensor, the audio sensors and the transceiver interface are coupled to the circuit board, and the processor is provided on the circuit board.

### BACKGROUND OF THE INVENTION

1. Field of the Invention

The present invention relates to an image/audio data sensing module and an image/audio data sensing method, and particularly relates to an image/audio data sensing module and an image/audio data sensing method utilizing a single transceiver interface.

2. Description of the Prior Art

Modern electronic apparatuses such as computers or mobile phones always include an image/audio data sensing module such as a camera module to perform follow up operations. FIG. 1 illustrates an example of a camera module incorporated in a computer screen case. As shown in FIG. 1, the computer screen 100 includes a camera module 101 comprising an image sensor 103 and an audio sensor 105. The image sensor 103 is used for sensing an image datum, and the audio sensor 105 is used for sensing an audio datum. The camera module 101 further includes a transceiver interface connected to the computer for outputting image data and audio data to the computer. However, the transceiver interface is not illustrated in FIG. 1.

Please refer to FIG. 2, which illustrates a block diagram of a prior art image/audio data sensing apparatus. As shown in FIG. 2, the sensed image datum DataV and audio datum DataA will be transmitted to the processor 205 for digitalization, and then the digitalized image datum DataV and audio datum DataA will be transmitted via different transceiver interfaces 207 and 209.

Such a structure, however, has some disadvantages. For example, if only one audio sensor is provided but directional audio collection is desired, the mechanical shape for the position where the audio sensor is provided must be changed. In this situation, the cost and design complexity increase. Furthermore, the improvement of directional audio collection effect due to mechanical shape amendment is largely limited.

Additionally, the image datum and audio datum must be transmitted to the electronic apparatus via different slots, since the image datum and audio datum correspond to different transceiver interfaces. Also, after the camera module is connected to the computer, the image datum and the audio datum must be transmitted to different transceiver interfaces via specific circuit board design. Besides, in the prior art, the synchronization of the audio datum and the image datum may be affected since a time difference problem may occur.

### SUMMARY OF THE INVENTION

Therefore, one objective of the present invention is to provide an image/audio data sensing module and an image/audio data sensing method, which utilize a single transceiver interface to transmit both an image datum and an audio datum. Another objective of the present invention is to provide an image data sensing module and an audio data sensing method, which can synchronize the image data and audio data.

One embodiment of the present invention discloses an image/audio data sensing module incorporated in a case of an electronic apparatus. The image/audio data sensing module comprises: at least one image sensor, for sensing an image datum; a plurality of audio sensors, for sensing at least one audio datum; a processor, for processing the image datum from the image sensor and the audio datum from the audio sensor according to a control instruction set of the electronic apparatus to generate a processed image data stream and at least one processed audio data stream, and combining the processed image data stream and the processed audio data stream to generate an output data stream following a transceiver interface standard; a transceiver interface, for receiving the control instructions and transmitting the output data stream via a multiplexing process; and a circuit board, wherein the image sensor, the audio sensors and the transceiver interface are coupled to the circuit board, and the processor is provided on the circuit board.

One embodiment of the present invention discloses an image/audio sensing method, utilized for an image/audio data sensing module, wherein the image/audio data sensing module is incorporated in a case of an electronic apparatus and comprises an image sensor, a plurality of audio sensors, a processor, a transceiver interface and a circuit board, where the image sensor, the audio sensors and the transceiver interface are coupled to the circuit board, and the processor is provided on the circuit board. The image/audio sensing method comprises: utilizing the image sensor to detect an image datum; utilizing the audio sensors to sense at least one audio datum; utilizing the processor to process the image datum from the image sensor and the audio datum from the audio sensor according to a control instruction set of the electronic apparatus to generate a processed image data stream and at least one processed audio data stream, and combine the processed image data stream and the processed audio data stream to generate an output data stream following a transceiver interface standard; and utilizing the transceiver interface to output the output data stream via a multiplexing process.

Another embodiment discloses an image/audio sensing method, utilized for an image/audio data sensing module, wherein the image/audio data sensing module is incorporated in a case of an electronic apparatus. The image/audio sensing method comprises: utilizing an image sensor to sense an image datum; utilizing a plurality of audio sensors to sense at least one audio data; utilizing a processor to process the image datum and the audio datum from the audio sensor according to a control instruction set of the electronic apparatus to generate a processed image data stream and at least one processed audio data stream; and utilizing a buffer to buffer at least part of the processed image data stream and the processed audio data stream, combining the buffered processed image data stream and the buffered processed audio data stream to generate the output data stream and outputting the output data stream to the transceiver interface after the processor processes the image datum and the audio datum sensed at the same time, wherein the image sensor, the audio sensors and the transceiver interface are coupled to the circuit board, and the processor is provided on the circuit board.

Via the abovementioned embodiments, directional audio collection can be performed in a DSP (digital signal processing) manner. Accordingly, different algorithms can be utilized for fine tuning indifferent environments, thus the mechanical shape does not need to be frequently changed. Furthermore, since two different data (image and audio) share the same transceiver interface, two different kinds of data can share the bandwidth of the signal line, such that the resource of a computer can be completely utilized. If the camera module can be designed to connect externally, the number of signal lines can be decreased. If the camera module is designed to be incorporated in the computer, the circuit board design can be simplified. Also, the problem of non synchronization between the image datum and the audio datum can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a camera module incorporated in a computer screen, according to the prior art.

FIG. 2 is a block diagram illustrating an image output apparatus, according to the prior art.

FIG. 3 is a block diagram illustrating an audio datum sensing module according to an embodiment of the present invention.

FIGS. 4a and 4b illustrate a bar-shaped camera module according to an embodiment of the present invention.

FIGS. 5 and 6 respectively illustrate an image/audio sensing method according to an embodiment of the present application.

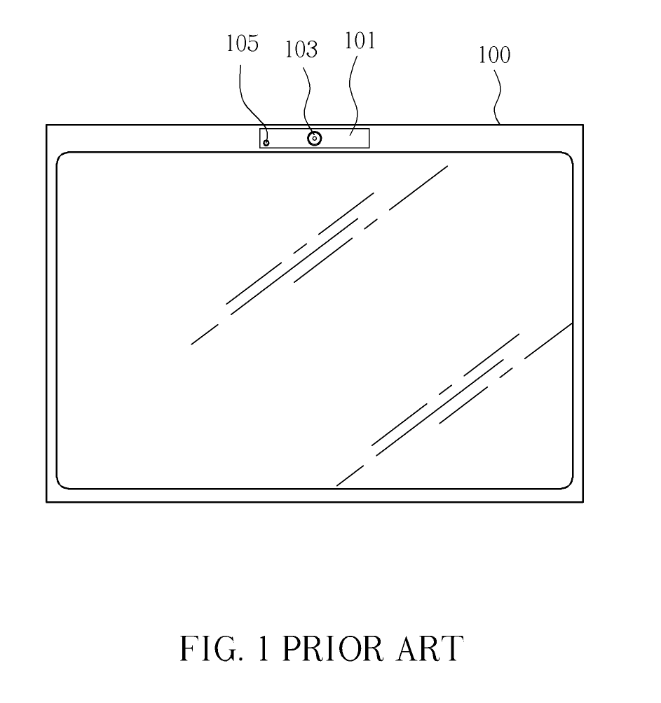

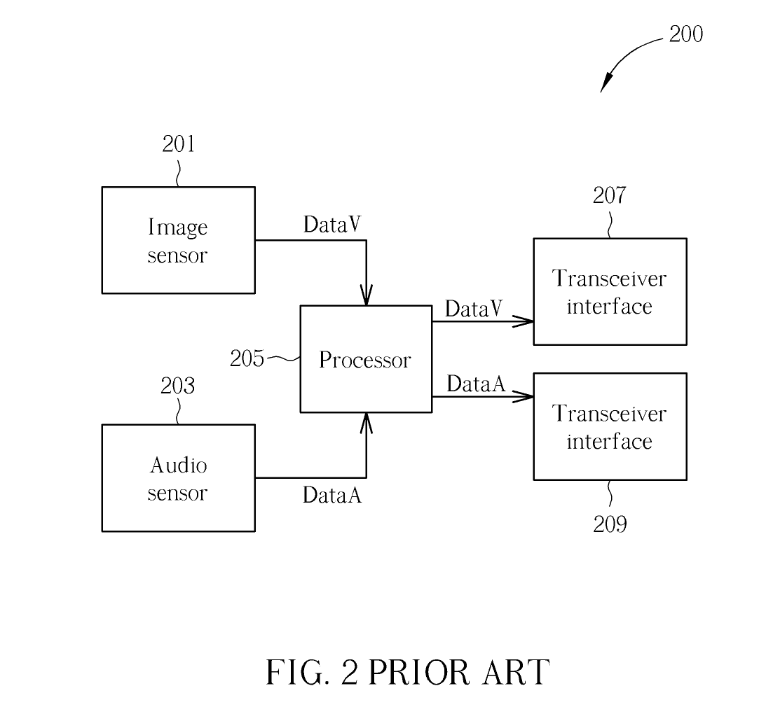

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

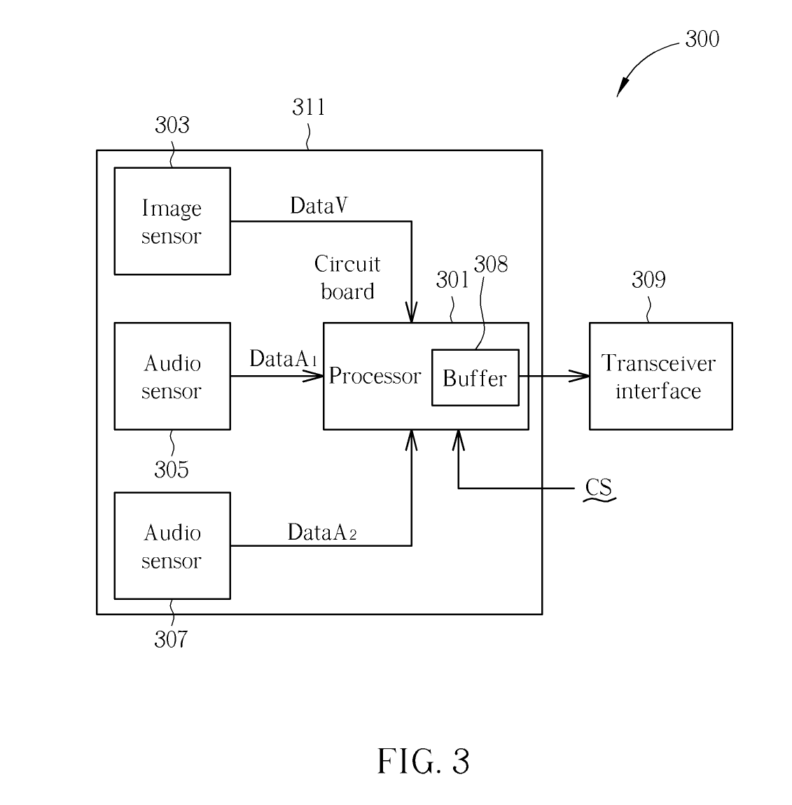

FIG. 3 is a block diagram illustrating an image/audio data sensing module 300 according to an embodiment of the present invention. Compared with the image/audio data sensing module 100, the image/audio data sensing module 300 also includes a processor 301 and an image sensor 303. If the image/audio data sensing module 300 is incorporated in a case of an electronic apparatus such as a computer, a mobile phone or a PDA, the processor 301 can be the micro processor of the electronic apparatus. Furthermore, the image/audio data sensing module 300 comprises a plurality of audio sensors (in this example, two audio sensors 305 and 307 are provided, but the number of audio sensors can be more than two) and a transceiver interface 309 (in this example, a USB interface is utilized). The image/audio data sensing module 300 can further comprise a circuit board 311. The image sensor 303, the audio sensors 305 and 307, and the transceiver interface 309 are electrically coupled to the circuit board 311 (one example welds the image sensor 303, the audio sensors 305 and 307 and the transceiver interface 309 to the circuit board 311, but this is not meant to limit the present invention). Additionally, the processor 301 is provided on the circuit board 311 to receive the control instruction CS from the image/audio data sensing module 300, and the processed image datum DataV and audio datum DataA₁, DataA₂.

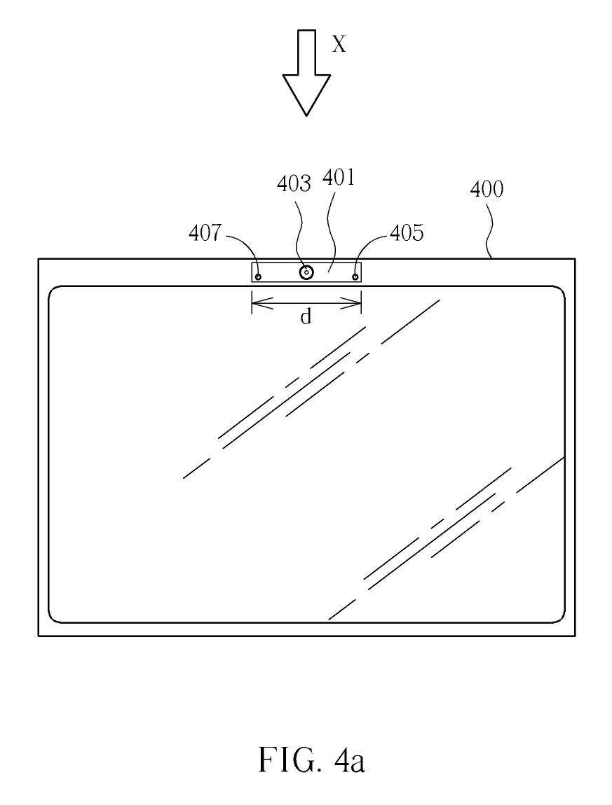

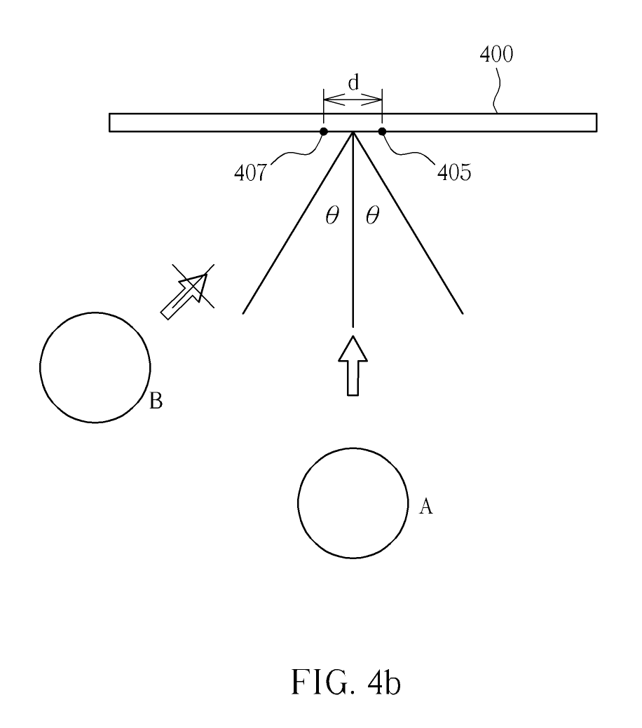

FIG. 4 illustrates an embodiment of the present application having two audio sensors. In FIG. 4, the audio sensors 405 and 407 are provided at two sides of the image sensor 403 to form a bar-shaped image/audio data sensing module 401 (also called a camera module). The sensed image datum DataV and audio data DataA₁, Data A₂ will be processed by the processor 301. The processor 301 digitalizes DataV, Data A₁, and Data A_{2,} if they are analog signals, and then combines the digitalized DataV, Data A₁, and Data A₂ to generate an output data stream following a transceiver interface standard for the transceiver interface 309. If DataV, Data A₁, and Data A₂ are digital signals, the processor 301 will combine DataV, Data A₁, and Data A₂ to generate an output data stream following a transceiver interface standard for the transceiver interface 309. If the transceiver interface 309 is a USB interface, the image datum DataV can be output according to the rules defined by UVC (USB Image Class) of USB protocol. Also, the audio data DataA1, DataA2 can be output according to the rules defined by UAC (USB Audio Class) of USB protocol. Additionally, in this embodiment, the above mentioned multiplexing process can be a frequency division multiplexing process or a time division multiplexing process.

Additionally, the transceiver interface 309 can be a USB high speed interface. If the transceiver interface 309 is a USB high speed interface, the transceiver interface 309 can comprise a power transmitting connection port, a ground connection port, a D+ connection port and a D− connection port. The transceiver interface 309 can also be a USB super speed interface. If the transceiver interface 309 is a USB super speed interface, the transceiver interface 309 comprise a power transmitting connection part, aground connection port, a SSRX+ connection part, a SSRX-connection port, a SSTX+ connection port and a SSTX− connection port. The transceiver interface 309 can further comprise a shielding connection port, coupled to a shielding of a USB cable. However, the transceiver interface 309 can also be other kinds of USB interfaces or other kinds of interfaces.

Also, a directional audio collection effect can be obtained if more than two audio sensors are utilized. One of the examples is described in the following. Please refer to FIGS. 4a and 4b, wherein FIG. 4b is a vertical view observed in the X direction of FIG. 4a. In this embodiment, a distance between the audio sensors 405 and 407 is d, and the computer in which the image/audio data sensing module 401 is provided can further comprise a memory inside (not illustrated). The memory can buffer the image datum and the audio datum from the transceiver interface, and the processor 301 can perform digitalization to the audio datum having a time difference more than dsinθwhile respectively reaching two audio sensors to suppress or omit such audio datum. By this way, directional audio collection in the area between A and B having an angle θ with respect to both sides of a point of origin equidistant between A and B can be acquired. If the angle θ is the angle at which the image frame can be clearly displayed to the user, the audio in the clearly displayed range of the image frame can be clearly sensed and the audio datum outside the clearly displayed range of the image frame can be well suppressed or omitted.

Additionally, a time difference may exists between image data and audio data, such that image and audio may have time differences while being displayed. The image/audio data sensing module 300 shown in FIG. 3 can further include a buffer 308. It should be noted that, although the buffer 308 is provided in the processor 301 in this embodiment, it does not mean to limit the scope of the present application. The buffer 308 can also be independent from the processor 301. In this embodiment, the buffer 308 is utilized for buffering at least part of the processed image data stream and the processed audio data stream. The processor 301 combines the buffered processed image data stream and the buffered processed audio data stream to generate the output data stream, and outputs the output data stream to the transceiver interface 309 after the processor 301 processes the image datum and the audio datum sensed at the same time. In this way, the time difference problem for image data and audio data can be avoided.

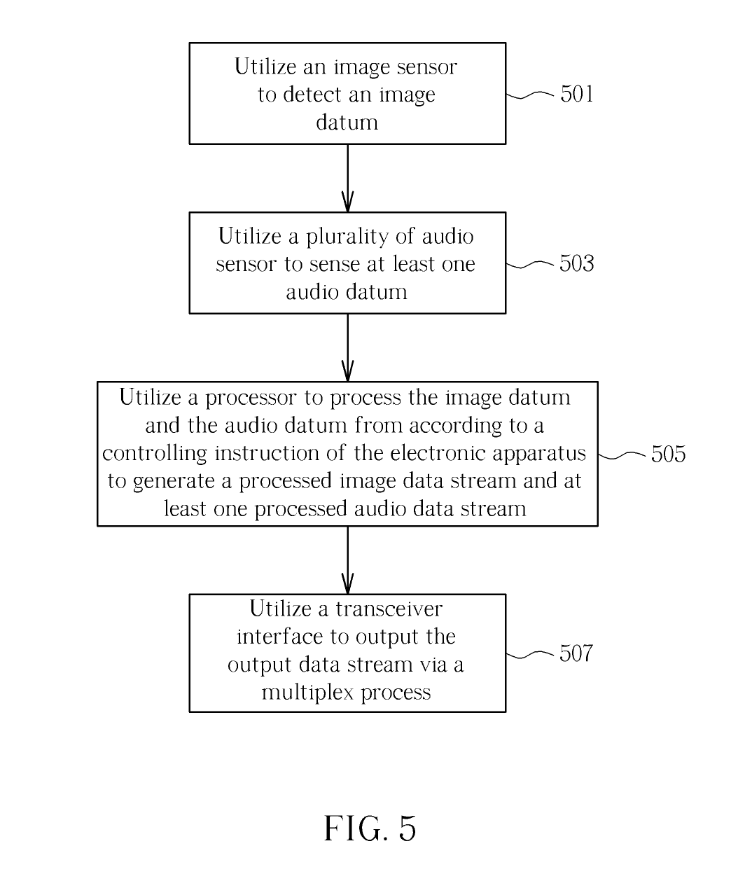

Via the above-mentioned embodiment, the image/audio sensing method shown in FIG. 5, which is utilized for a sensing module incorporated in a case of an electronic apparatus, can be acquired. Please refer to FIGS. 3 and 5 to understand the present invention more clearly. As shown in FIG. 5, the image/audio sensing method according to an embodiment of the present invention comprises:

Step 501

Utilize an image sensor (303) to detect an image datum.

Step 503

Utilize a plurality of audio sensors (305, 307) to detect at least one audio datum.

Step 505

Utilize a processor to process the image datum and the audio datum according to a control instruction set of the electronic apparatus to generate a processed image data stream and at least one processed audio data stream, and combine the processed image data stream and the processed audio data stream to generate an output data stream following a transceiver interface (309) standard.

Step 507

Utilize a transceiver interface (309) to output the output data stream via a multiplexing process.

Other detailed characteristics are already disclosed in the above mentioned embodiments, and thus are omitted here for brevity.

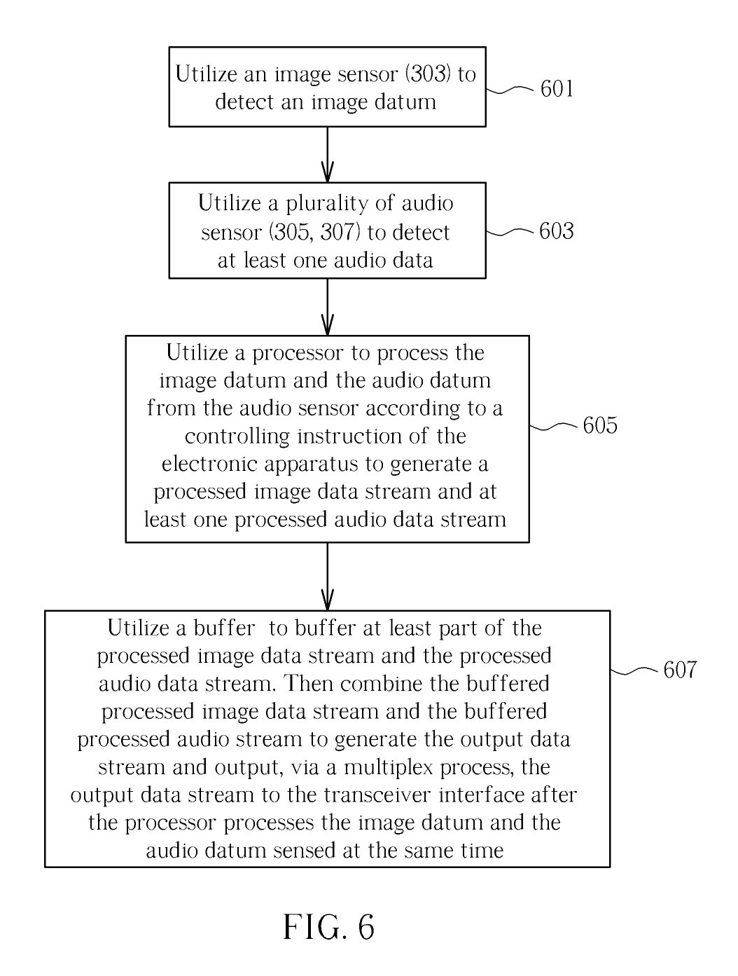

According to the above mentioned description, the image/audio sensing method shown in FIG. 6, which is utilized for a sensing module incorporated in a case of an electronic apparatus, can be acquired. Please refer to FIGS. 3 and 6 to under stand the present invention more clearly. As shown in FIG. 6, the image/audio sensing method according to the present invention can comprise:

Step 601: Utilize an image sensor (303) to detect an image datum.

Step 603: Utilize a plurality of audio sensors (305, 307) to detect at least one audio datum.

Step 605: Utilize a processor to process the image datum and the audio datum according to a control instruction set of the electronic apparatus to generate a processed image data stream and at least one processed audio data stream.

Step 607: Utilize a buffer (308) to buffer at least part of the processed image data stream and the processed audio data stream. Then combine the buffered processed image data stream and the buffered processed audio data stream to generate the output data stream and output, via a multiplexing process, the output data stream to the transceiver interface after the processor processes the image datum and the audio datum sensed at the same time.

Other detailed characteristics are already disclosed in the above mentioned embodiments, and thus are omitted here for brevity.

Via the abovementioned embodiments, directional audio collection can be performed in a DSP (digital signal processing) manner. Accordingly, different algorithms can be utilized in different environments, thus the mechanical shape does not needed to be frequently changed. Furthermore, since two different data share the same transceiver interface, two different kinds of data can share the bandwidth of a single signal line, such that the resource of a computer can be completely utilized. If the camera module can be designed to be connected externally, the number of signal lines number can be decreased. If the camera module is designed to be incorporated in the computer, the circuit board design can be simplified. Also, the problem of non synchronization between the image data and the audio data can be improved.

Those skilled in the art will readily observe that numerous modifications and alterations of the device and method may be made while retaining the teachings of the invention.

What is claimed is:

1. An image/audio data sensing module, incorporated in a case of an electronic apparatus, comprising:
at least one image sensor, for sensing an image datum;
a plurality of audio sensors, for sensing at least one audio datum;
a processor, for processing the image datum from the image sensor and the audio datum from the audio sensor according to a control instruction set of the electronic apparatus to generate a processed image data stream and at least one processed audio data stream, and combining the processed image data stream and the processed audio data stream to generate an output data stream following a transceiver interface standard;
a transceiver interface, for receiving the control instruction set and transmitting the output data stream via a multiplexing process; and
a circuit board, wherein the image sensor, the audio sensors and the transceiver interface are coupled to the circuit board, and the processor is provided on the circuit board.

2. The image/audio data sensing module of claim 1, wherein the processor further comprises a buffer, for buffering at least part of the processed image data stream and the processed audio data stream, where the processor combines the buffered processed image data stream and the buffered processed audio data stream to generate the output data stream and outputs the output data stream to the transceiver interface after the processor processes the image datum and the audio datum sensed at the same time.

3. The image/audio data sensing module of claim 1, wherein the multiplexing process is a frequency division multiplexing process or a time division multiplexing process.

4. The image/audio data sensing module of claim 1, wherein the transceiver interface is a USB interface, and the multiplexing process is a time division multiplexing process.

5. The image/audio data sensing module of claim 4, wherein the transceiver interface is a USB high speed interface, and the transceiver interface comprises a power transmitting connection port, a ground connection port, a D+ connection port and a D− connection port.

6. The image/audio data sensing module of claim 5, wherein the transceiver interface further comprises a shielding connection port coupled to a shielding of a USB cable.

7. The image/audio data sensing module of claim 4, wherein the transceiver interface is a USB super speed interface, where the transceiver interface comprises a power transmitting connection part, a ground connection port, a SSRX+ connection part, a SSRX− connection port, a SSTX+ connection port and a SSTX− connection port.

8. The image/audio data sensing module of claim 7, wherein the transceiver interface further comprises a shielding connection port coupled to a shielding of a USB cable.

9. An image/audio data sensing method, utilized for an image/audio data sensing module, wherein the image/audio data sensing module is incorporated in a case of an electronic apparatus and comprises an image sensor, a plurality of audio sensors, a processor, a transceiver interface and a circuit board, where the image sensor, the audio sensors and the transceiver interface are coupled to the circuit board, and the processor is provided on the circuit board, the image/audio sensing method comprising;
utilizing the image sensor to sense an image datum;
utilizing the audio sensors to sense at least one audio datum;
utilizing the processor to process the image datum from the image sensor and the audio datum from the audio sensor according to a control instruction set of the electronic apparatus to generate a processed image data stream and at least one processed audio data stream, and combine the processed image data stream and the processed audio data stream to generate an output data stream following a transceiver interface standard; and
utilizing the transceiver interface to output the output data stream via a multiplexing process.

10. The image/audio data sensing method of claim 9, further comprising:
buffering at least part of the processed image data stream and the processed audio data stream, combining the buffered processed image data stream and the buffered processed audio data stream to generate the output data stream and outputting the output data stream to the transceiver interface after the processor processes the image datum and the audio datum sensed at the same time.

11. The image/audio data sensing method of claim 9, wherein the multiplexing process is a frequency division multiplexing process or a time division multiplexing process.

12. The image/audio data sensing method of claim 9, wherein the transceiver interface is a USB interface, and the multiplexing process is a time division multiplexing process.

13. The image/audio data sensing method of claim 12, wherein the transceiver interface is a USB high speed interface, and the transceiver interface comprises a power transmitting connection port, a ground connection port, a D+ connection port and a D− connection port.

14. The image/audio data sensing method of claim 13, wherein the transceiver interface further comprises a shielding connection port coupled to a shielding of a USB cable.

15. The image/audio data sensing method of claim 12, wherein the transceiver interface is a USB super speed interface, where the transceiver interface comprises a power transmitting connection part, a ground connection port, a SSRX+ connection part, a SSRX-connection port, a SSTX+ connection port and a SSTX− connection port.

16. The image/audio data sensing method of claim 15, wherein the transceiver interface further comprises a shielding connection port coupled to a shielding of a USB cable.

17. An image/audio data sensing method, utilized for an image/audio data sensing module, wherein the image/audio data sensing module is incorporated in a case of an electronic apparatus, the image/audio sensing method comprising:
utilizing an image sensor to sense an image datum;
utilizing a plurality of audio sensors to sense at least one audio datum;
utilizing a processor to process the image datum and the audio datum from the audio sensor according to a control instruction set of the electronic apparatus to generate a processed image data stream and at least one processed audio data stream; and
utilizing a buffer to buffer at least part of the processed image data stream and the processed audio data stream, combining the buffered processed image data stream and the buffered processed audio data stream to generate the output data stream and outputting the output data stream to the transceiver interface after the processor processes the image datum and the audio datum sensed at the same time, wherein the image sensor, the audio sensors and the transceiver interface are coupled to the circuit board, and the processor is provided on the circuit board.
